(19) United States
(12) Patent Application Publication
(10) Pub. No.: US 2016/0358170 A1
(43) Pub. Date: Dec. 8, 2016

(54) TRANSACTION AUTHORIZATION USING QUASI-ACCOUNTS

(71) Applicant: Bank of America Corporation, Charlotte, NC (US)

(72) Inventor: Manu Kurian, Dallas, TX (US)

(21) Appl. No.: 14/733,869

(22) Filed: Jun. 8, 2015

(51) Int. Cl. G06Q 20/40; G06Q 20/10

(52) U.S. Cl. CPC G06Q 20/401; G06Q 20/10

(57) ABSTRACT

A computing platform may generate a request for a quasi-account number for an account at a financial institution, may receive the quasi-account number from the financial institution, and may communicate the quasi-account number to a computing system associated with the account. The computing platform may receive one or more authorization parameters for the quasi-account number from the computing system and may utilize a balance associated the account to establish a balance for a quasi-account having the quasi-account number in accordance with the authorization parameter(s). A transaction request may be received to transfer an amount from the quasi-account to a different account, and the computing system may determine whether to authorize the request based on the balance for the quasi-account. The quasi-account number may be formatted similarly to an account number for the account, and the similarity of the format may enable the computing platform to support transactions comprising inter-institution transfers.

### BACKGROUND

Traditionally, a party to a transaction seeking to transfer funds or otherwise make payment to a counterpart must provide the counterpart with its account number. While the transaction that brings about the exchange of the account number may be authorized, the account number may be valid well into the future. For example, many credit and debit card account numbers are valid for years, and most deposit account numbers are intended to remain valid indefinitely. Widespread sharing of an account number may therefore increase the susceptibility of the account to unauthorized transactions. While a few existing approaches support authorization of transactions without requiring that an account number be exchanged between the parties, these approaches often require the introduction of a third party, which is provided the account number in lieu of the transaction counterpart—shifting and perhaps reducing the risk of unauthorized transactions. The addition of a third party, however, usually requires both parties adopt new infrastructure. And these models typically fail because the third party is unable to garner widespread adoption. Accordingly, a need exists for transaction authorization using quasi-accounts.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

In accordance with one or more embodiments, a computing platform may generate a request for a quasi-account number for an account at a financial institution, may receive the quasi-account number from the financial institution, and may communicate the quasi-account number to a computing system associated with the account. The computing platform may receive one or more authorization parameters for the quasi-account number from the computing system and may utilize a balance associated the account to establish a balance for a quasi-account having the quasi-account number in accordance with the authorization parameter(s). A transaction request may be received to transfer an amount from the quasi-account to a different account, and the computing system may determine whether to authorize the request based on the balance for the quasi-account. The quasi-account number may be formatted similarly to an account number for the account, and the similarity of the format may enable the computing platform to support transactions comprising inter-institution transfers.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for transaction authorization using quasi-accounts in accordance with one or more example embodiments;

FIG. 4 depicts an illustrative event sequence for transaction authorization using quasi-accounts in accordance with one or more example embodiments; and

FIG. 5 depicts an illustrative method for transaction authorization using quasi-accounts in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

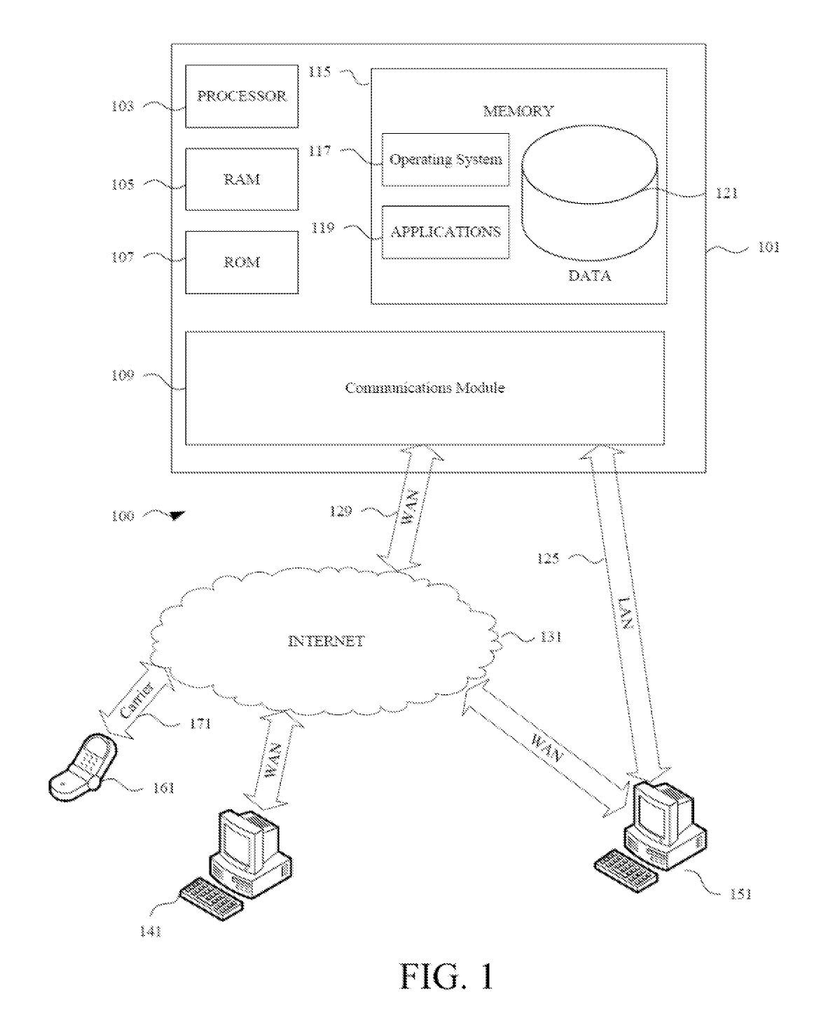

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

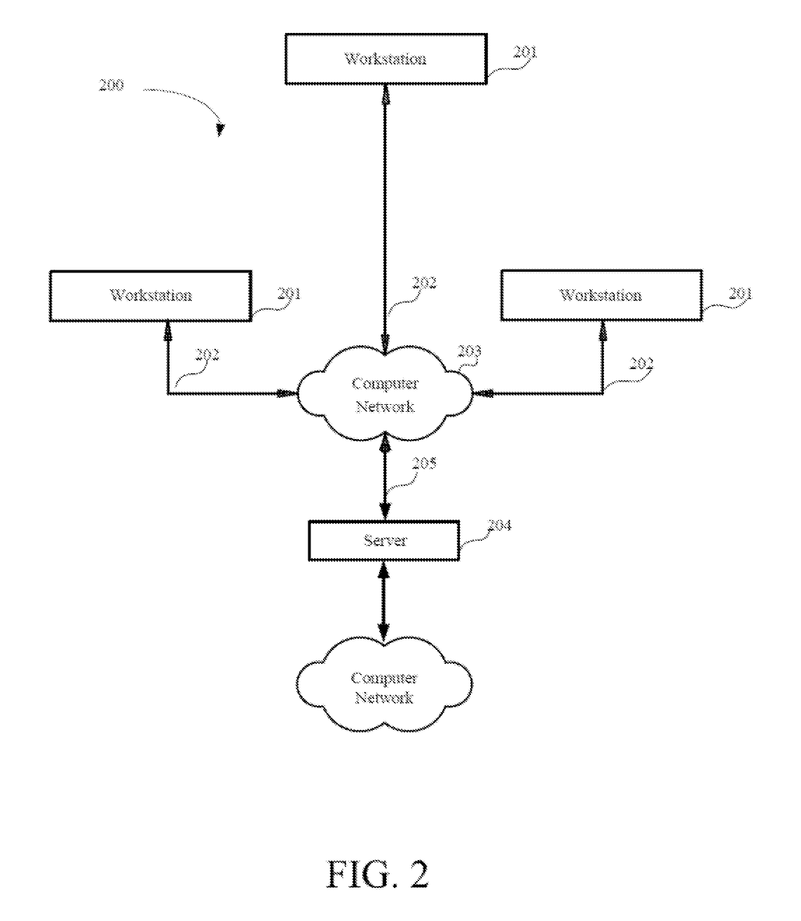

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

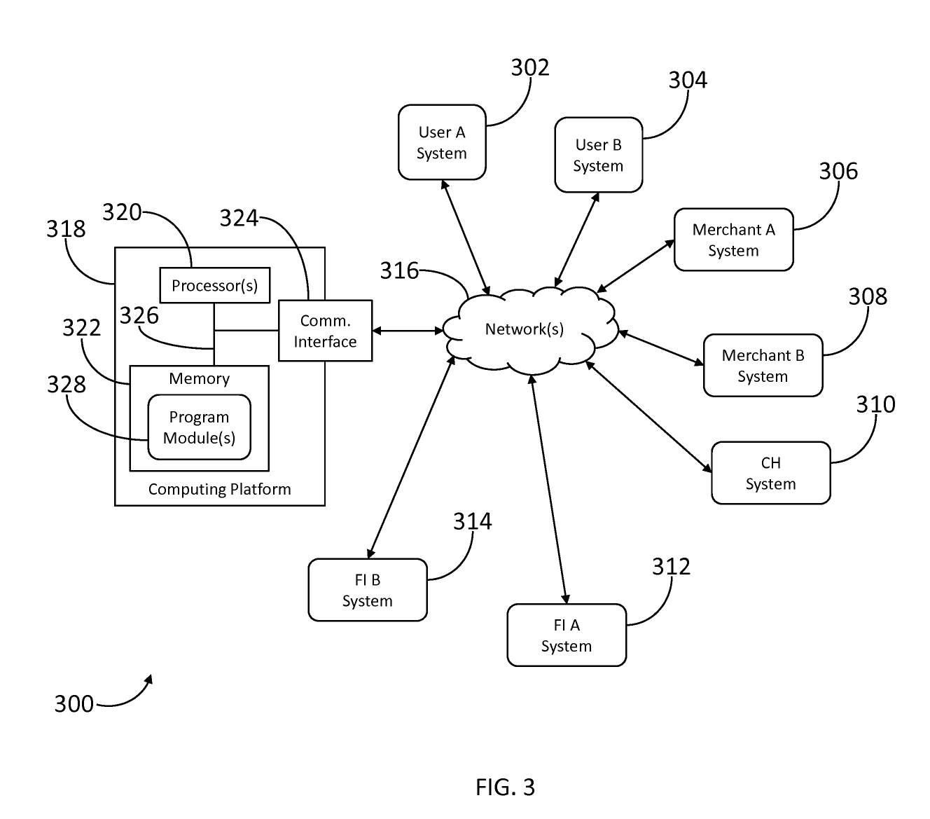

FIG. 3 depicts an illustrative computing environment for transaction authorization using quasi-accounts in accordance with one or more example embodiments. Referring to FIG. 3, computing environment 300 may include one or more computing systems. For example, computing environment 300 may include computing system 302, 304, 306, 308, 310, 312, and 314. Computing systems 302, 304, 306, 308, 310, 312, and 314 may include one or more of any type of computing device (e.g., desktop computer, laptop computer, tablet computer, smart phone, server, server blade, mainframe, virtual machine, or the like) configured to perform one or more of the functions described herein. Computing environment 300 may also include one or more networks. For example, computing environment 300 may include network(s) 316, which may include one or more sub-networks (e.g., LANs, WANs, VPNs, or the like) and may interconnect one or more computing devices of computing systems 302, 304, 306, 308, 310, 312, or 314.

Computing environment 300 may comprise a computing platform, and, in some embodiments, computing platform 318 may include one or more computing devices of computing systems 302, 304, 306, 308, 310, 312, or 314. Computing platform 318 may include one or more processor(s) 320, memory 322, communication interface 324, and/or data bus 326. Data bus 326 may interconnect processor(s) 320, memory 322, and/or communication interface 324. Communication interface 324 may be a network interface configured to support communications between computing platform 318 and network(s) 306 (or one or more sub-networks thereof) (e.g., communications between one or more computing devices of computing systems 302, 304, 306, 308, 310, 312, or 314). Memory 322 may include program module(s) 328, which may comprise instructions that when executed by processor(s) 320 cause computing platform 318 to perform one or more functions described herein.

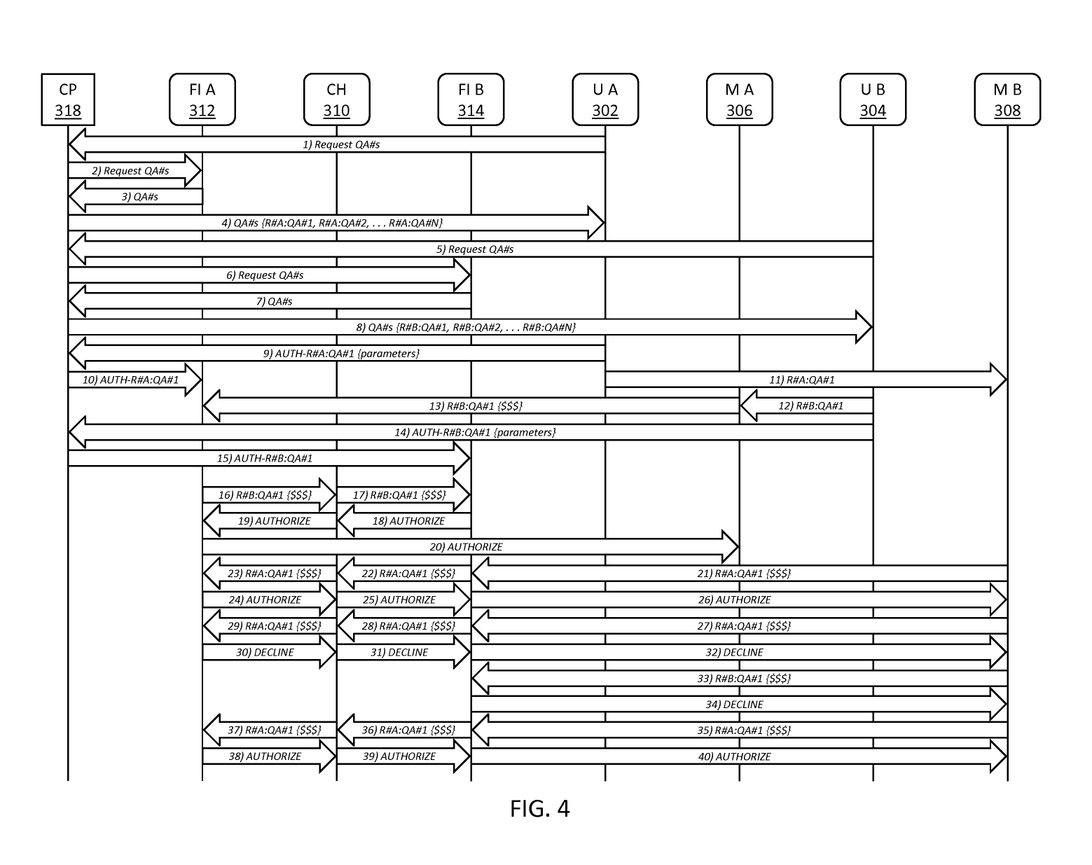

FIG. 4 depicts an illustrative event sequence for transaction authorization using quasi-accounts in accordance with one or more example embodiments. Referring to FIG. 4, at step 1, computing system 302 may generate a request for one or more quasi-account numbers and may communicate (e.g., via network(s) 316) the request to computing platform 318, which may receive the request (e.g., via communication interface 324). For example, computing system 302 may be associated with a holder of an account (e.g., user A) at a financial institution associated with computing platform 318 (e.g., FI A), and the holder of the account may desire to utilize quasi-account(s) for transaction authorization in accordance with one or more embodiments described herein and may utilize computing system 302 to generate a request for the quasi-account number(s). At step 2, computing platform 318 may generate a request for the quasi-account number(s) and may communicate the request (e.g., via communication interface 324) to computing system 312. For example, computing system 312 may be associated with the financial institution (e.g., FI A) at which the account (e.g., of user A) is maintained, and computing platform 318 may determine (e.g., based on the request received from computing system 302) that the quasi-account number(s) should be requested from computing system 312 (e.g., FI A). At step 3, computing system 312 may generate the quasi-account number(s) (e.g., R#A:QA#1, R#A:QA#2, . . . R#A:QA#N) and may communicate the quasi-account number(s) to computing platform 318, which, at step 4, may generate and communicate (or forward) a message comprising the quasi-account number(s) to computing system 302 for utilization by the holder of the account (e.g., user A).

Similarly, at step 5, computing system 304 may be associated with a holder of an account (e.g., user B) at a financial institution associated with computing platform 318 (e.g., FI B), and the holder of the account may desire to utilize quasi-account(s) for transaction authorization in accordance with one or more embodiments described herein and may utilize computing system 304 to generate a request for quasi-account number(s) and communicate the request to computing platform 318. At step 6, computing platform 318 may determine (e.g., based on the request received from computing system 304) that the quasi-account number(s) should be requested from computing system 314 (e.g., computing system 314 may be associated with the financial institution (e.g., FI B) at which the account (e.g., of user B) is maintained) and may generate a request for the quasi-account number(s) and communicate the request to computing system 314. At step 7, computing system 314 may generate the quasi-account number(s) (e.g., R#B:QA#1, R#B:QA#2, . . . R#B:QA#N) and may communicate the quasi-account number(s) to computing platform 318, which, at step 8, may forward the quasi-account number(s) to computing system 304 for utilization by the holder of the account (e.g., user B).

The quasi-account numbers may be associated with their respective financial institutions (e.g., FI A and FI B) and accounts (e.g., the account of user A with FI A and the account of user B with FI B) but may not comprise the actual account numbers of the underlying accounts. In some embodiments, the quasi-account numbers may be similarly formatted to the account numbers of the underlying accounts. For example, each of the quasi-account numbers may comprise a first portion comprising a routing number (e.g., a nine digit number) associated with its respective financial institution (e.g., R#A may be a routing number associated with FI A and R#B may be a routing number associated with FI B) and a second portion having a format (e.g., a number comprising more than nine digits) similar to the account number of the underlying account (e.g., QA#1, QA#2, . . . QA#N may be similar in format to the account numbers of the underlying accounts of user A and user B with FI A and FI B).

At step 9, computing system 302 may generate a message comprising a quasi-account number (e.g., R#A:QA#1) and one or more authorization parameters. In some embodiments, the authorization parameter(s) may comprise data indicating that a recurring charge of a particular amount is authorized for the quasi-account number at a specified interval (e.g., user A may be a tenant of merchant B and the authorization parameter(s) may comprise data indicating that an amount corresponding to the rent due to merchant B from user A is authorized for the quasi-account number once a month for the next twelve months).

At step 10, computing platform 318 may generate instructions configured to cause computing system 312 (e.g., FI A) to utilize a balance of the underlying account (e.g., user A's account) to establish a balance for a quasi-account associated with the quasi-account number (e.g., R#A:QA#1) in accordance with the authorization parameter(s), and computing platform 318 may communicate the instructions to computing system 312, which may execute the instructions (e.g., utilize, allocate, transfer, or the like a balance (e.g., available credit or deposited funds) of user A's account with FI A to establish a balance comprising the rent due for the quasi-account associated with the quasi-account number (e.g., R#A:QA#1) at the beginning of each of the next twelve months). At step 11, computing system 302 (e.g., user A) may generate a message comprising the quasi-account number (e.g., R#A:QA#1) and may communicate the message to computing system 308 (e.g., a computing system associated with merchant B).

At step 12, computing system 304 (e.g., user B) may generate a message comprising the quasi-account number (e.g., R#B:QA#1) and may communicate the message to computing system 306 (e.g., a computing system associated with merchant A), which, at step 13, may utilize the quasi-account number to generate a transaction authorization request for a particular amount and may communicate the transaction authorization request to computing system 312 (e.g., merchant A may have an account at FI A, user B may have entered into a transaction for the amount with merchant A and may have communicated the quasi-account number (e.g., R#B:QA#1) as a form of payment for the amount due by user B to merchant A, and merchant A may have utilized computing system 306 to generate a request for the amount to be transferred from the quasi-account associated with the quasi-account number (e.g., R#B:QA#1) to the account of merchant A at FI A). At step 14, computing system 304 may generate a message comprising the quasi-account number (e.g., R#B:QA#1) and one or more authorization parameters.

In some embodiments, the authorization parameter(s) may comprise data indicating that a one-time charge of a particular amount is authorized for the quasi-account number (e.g., user B may have, contemporaneous to entering into the transaction for the amount with merchant A, utilized computing system 304 to generate a message comprising the quasi-account number (e.g., R#B:QA#1) and one or more authorization parameters indicating that a one-time charge of the amount of the transaction with merchant A is authorized). At step 15, computing platform 318 may generate instructions configured to cause computing system 314 (e.g., FI B) to utilize a balance of the underlying account (e.g., user B's account) to establish a balance for a quasi-account associated with the quasi-account number (e.g., R#B:QA#1) in accordance with the authorization parameter(s), and computing platform 318 may communicate the instructions to computing system 314, which may execute the instructions (e.g., utilize, allocate, transfer, or the like a balance (e.g., available credit or deposited funds) of user B's account with FI B to establish a balance comprising the amount of the transaction with merchant A for the quasi-account associated with the quasi-account number (e.g., R#B:QA#1)).

At step 16, computing system 312 (e.g., FI A) may determine (e.g., based on R#B) that the transaction authorization request (e.g., received in step 13 above) comprising the quasi-account number (e.g., R#B:QA#1) communicated by computing system 304 (e.g., user B) to computing system 306 (e.g., merchant A) is associated with an account of a different financial institution (e.g., FI B) and may forward the transaction authorization request to computing system 310. Computing system 310 may be associated with an inter-financial-institution-transaction clearinghouse and, upon receiving the transaction authorization request, may determine (e.g., based on R#B) that the transaction authorization request should be routed to computing system 314 (e.g., FI B) and, at step 17, may forward the transaction authorization request to computing system 314 (e.g., FI B).

At step 18, computing system 314 may determine that the quasi-account associated with the quasi-account number included in the transaction authorization request (e.g., R#B:QA#1) has a balance comprising the amount included in the transaction authorization request (e.g., the balance established in step 15 above), may transfer the amount requested by the transaction authorization request to an account associated with computing system 312 (e.g., FI A) for transfer by computing system 312 (e.g., FI A) to an account associated with computing system 306 (e.g., the account of merchant A with FI A) and, at step 18, may generate a message (e.g., an authorization confirmation) indicating that the transaction authorization request is authorized and may communicate the message indicating that the transaction authorization request is authorized to computing system 310 (e.g., the inter-financial-institution-transaction clearinghouse), which, at step 19, may forward the message to computing system 312 (e.g., FI A), which, at step 20, may forward the message to computing system 306 (e.g., merchant A).

At step 21, computing system 308 (e.g., merchant B) may utilize the quasi-account number (e.g., R#A:QA#1) communicated (e.g., in step 11 above) by computing system 302 (e.g., user A) to generate a transaction authorization request for a particular amount (e.g., the amount of rent due to merchant B from user A) and may communicate the transaction authorization request to computing system 314 (e.g., merchant B may have an account at FI B, and merchant B may have utilized computing system 308 to generate a request for the amount (e.g., the amount of rent due to merchant B from user A) to be transferred from the quasi-account associated with the quasi-account number (e.g., R#A:QA#1) to the account of merchant B at FI B). At step 22, computing system 314 (e.g., FI B) may determine (e.g., based on R#A) that the transaction authorization request (e.g., received in step 21 above) comprising the quasi-account number (e.g., R#A:QA#1) communicated by computing system 302 (e.g., user A) to computing system 308 (e.g., merchant B) is associated with an account of a different financial institution (e.g., FI A) and may forward the transaction authorization request to computing system 310 (e.g., the inter-financial-institution-transaction clearinghouse). Upon receiving the transaction authorization request, computing system 310 may determine (e.g., based on R#A) that the transaction authorization request should be routed to computing system 312 (e.g., FI A) and, at step 23, may forward the transaction authorization request to computing system 312 (e.g., FI A).

Computing system 312 may determine that the quasi-account associated with the quasi-account number included in the transaction authorization request (e.g., R#A:QA#1) has a balance comprising the amount included in the transaction authorization request (e.g., pursuant to the authorization parameters received in step 10 above, computing system 312 may have established (e.g., at the beginning of the month) a balance comprising the amount (e.g., the amount of rent due to merchant B from user A) in the quasi-account associated with the quasi-account number (e.g., R#A:QA#1)), may transfer the amount requested by the transaction authorization request to an account associated with computing system 314 (e.g., FI B) for transfer by computing system 314 (e.g., FI B) to an account associated with computing system 308 (e.g., the account of merchant B with FI B) and, at step 24, may generate a message (e.g., an authorization confirmation) indicating that the transaction authorization request is authorized and may communicate the message indicating that the transaction authorization request is authorized to computing system 310 (e.g., the inter-financial-institution-transaction clearinghouse), which, at step 25, may forward the message to computing system 314 (e.g., FI B), which, at step 26, may forward the message to computing system 308 (e.g., merchant B).

At step 27, computing system 308 (e.g., merchant B) may utilize the quasi-account number (e.g., R#A:QA#1) communicated (e.g., in step 11 above) by computing system 302 (e.g., user A) to generate a transaction authorization request for a particular amount (e.g., the amount of rent due to merchant B from user A) and may communicate the transaction authorization request to computing system 314 (e.g., merchant B may have utilized computing system 308 to generate another request for the amount (e.g., the amount of rent due to merchant B from user A) to be transferred from the quasi-account associated with the quasi-account number (e.g., R#A:QA#1) to the account of merchant B at FI B). At step 28, computing system 314 (e.g., FI B) may determine (e.g., based on R#A) that the transaction authorization request (e.g., received in step 27 above) comprising the quasi-account number (e.g., R#A:QA#1) communicated by computing system 302 (e.g., user A) to computing system 308 (e.g., merchant B) is associated with an account of a different financial institution (e.g., FI A) and may forward the transaction authorization request to computing system 310 (e.g., the inter-financial-institution-transaction clearinghouse). Upon receiving the transaction authorization request, computing system 310 may determine (e.g., based on R#A) that the transaction authorization request should be routed to computing system 312 (e.g., FI A) and, at step 29, may forward the transaction authorization request to computing system 312 (e.g., FI A).

Computing system 312 may determine that the quasi-account associated with the quasi-account number included in the transaction authorization request (e.g., R#A:QA#1) has a balance that does not comprise the amount included in the transaction authorization request (e.g., pursuant to the authorization parameters received in step 10 above, computing system 312 may have established (e.g., at the beginning of the month) a balance comprising the amount (e.g., the amount of rent due to merchant B from user A) in the quasi-account associated with the quasi-account number (e.g., R#A:QA#1), but the balance may have been reduced (e.g., in association with the transaction authorization request received in step 21 above), for example, merchant B may have erroneously requested the amount (e.g., the amount of rent due to merchant B from user A) twice during the same month) and, at step 30, may generate a message (e.g., a decline notification) indicating that the transaction authorization request is not authorized because the quasi-account associated with the quasi-account number (e.g., R#A:QA#1) does not comprise the amount and may communicate the message indicating that the transaction authorization request is not authorized to computing system 310 (e.g., the inter-financial-institution-transaction clearinghouse), which, at step 31, may forward the message to computing system 314 (e.g., FI B), which, at step 32, may forward the message to computing system 308 (e.g., merchant B).

At step 33, computing system 308 (e.g., merchant B) may generate a transaction authorization request comprising the quasi-account number (e.g., R#B:QA#1) communicated (e.g., in step 12 above) by computing system 304 (e.g., user B) to computing system 306 (e.g., merchant A) for a particular amount and may communicate the transaction authorization request to computing system 314 (e.g., FI B). For example, the quasi-account number (e.g., R#B:QA#1) may have been communicated by a computing system other than computing system 304 (e.g., an unauthorized user) to computing system 308 (e.g., merchant B).

Computing system 314 may determine that the quasi-account associated with the quasi-account number included in the transaction authorization request (e.g., R#B:QA#1) has a balance that does not comprise the amount included in the transaction authorization request (e.g., pursuant to the authorization parameters received in step 15 above, computing system 314 may have established a balance comprising the amount for the one-time charge of the particular amount (e.g., the amount of the transaction of user B with merchant A), but the balance may have been reduced (e.g., in association with the transaction authorization request received in step 17 above) and, at step 34, may generate a message (e.g., a decline notification) indicating that the transaction authorization request is not authorized because the quasi-account associated with the quasi-account number (e.g., R#B:QA#1) does not comprise the amount and may communicate the message indicating that the transaction authorization request is not authorized to computing system 308 (e.g., merchant B).

At step 35, computing system 308 (e.g., merchant B) may utilize the quasi-account number (e.g., R#A:QA#1) communicated (e.g., in step 11 above) by computing system 302 (e.g., user A) to generate a transaction authorization request for a particular amount (e.g., the amount of rent due to merchant B from user A) and may communicate the transaction authorization request to computing system 314 (e.g., merchant B may have utilized computing system 308 to generate another request for the amount (e.g., the amount of rent due to merchant B from user A) to be transferred from the quasi-account associated with the quasi-account number (e.g., R#A:QA#1) to the account of merchant B at FI B). At step 36, computing system 314 (e.g., FI B) may determine (e.g., based on R#A) that the transaction authorization request (e.g., received in step 35 above) comprising the quasi-account number (e.g., R#A:QA#1) communicated by computing system 302 (e.g., user A) to computing system 308 (e.g., merchant B) is associated with an account of a different financial institution (e.g., FI A) and may forward the transaction authorization request to computing system 310 (e.g., the inter-financial-institution-transaction clearinghouse). Upon receiving the transaction authorization request, computing system 310 may determine (e.g., based on R#A) that the transaction authorization request should be routed to computing system 312 (e.g., FI A) and, at step 37, may forward the transaction authorization request to computing system 312 (e.g., FI A).

Computing system 312 may determine that the quasi-account associated with the quasi-account number included in the transaction authorization request (e.g., R#A:QA#1) has a balance comprising the amount included in the transaction authorization request (e.g., pursuant to the authorization parameters received in step 10 above, computing system 312 may have established (e.g., at the beginning of the month (e.g., a new month)) a balance comprising the amount (e.g., the amount of rent due to merchant B from user A) in the quasi-account associated with the quasi-account number (e.g., R#A:QA#1)), may transfer the amount requested by the transaction authorization request to an account associated with computing system 314 (e.g., FI B) for transfer by computing system 314 (e.g., FI B) to an account associated with computing system 308 (e.g., the account of merchant B with FI B) and, at step 38, may generate a message (e.g., an authorization confirmation) indicating that the transaction authorization request is authorized and may communicate the message indicating that the transaction authorization request is authorized to computing system 310 (e.g., the inter-financial-institution-transaction clearinghouse), which, at step 39, may forward the message to computing system 314 (e.g., FI B), which, at step 40, may forward the message to computing system 308 (e.g., merchant B).

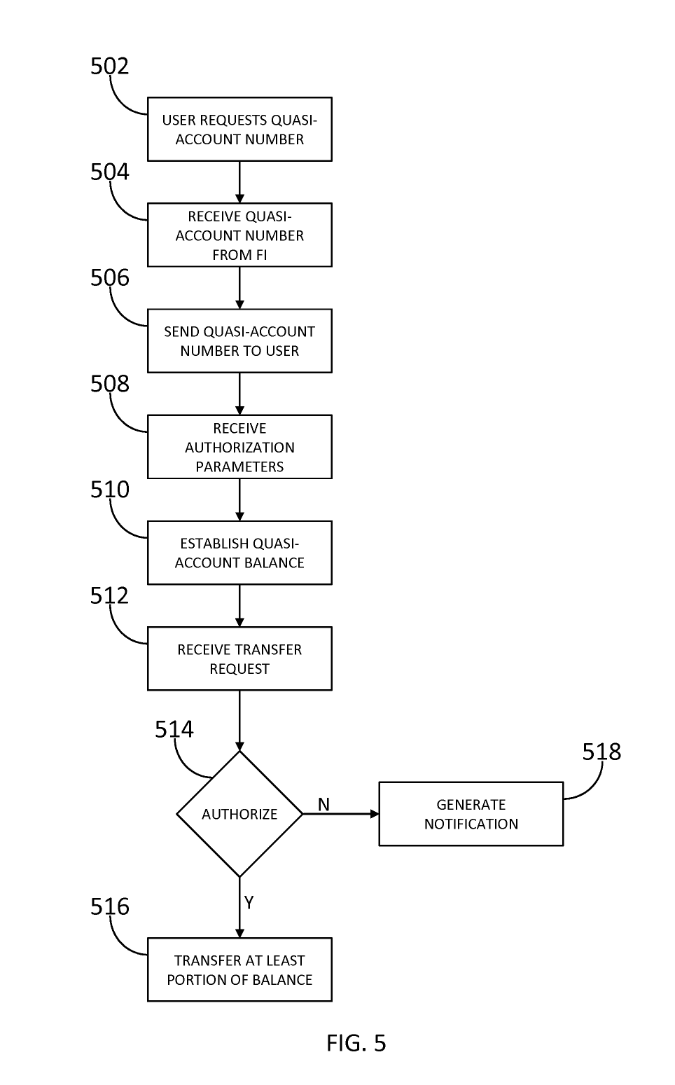

FIG. 5 depicts an illustrative method for transaction authorization using quasi-accounts in accordance with one or more example embodiments. Referring to FIG. 5, at step 502, a user may request a quasi-account number. For example, computing platform 318 may receive a request for a quasi-account number from computing system 302 (e.g., user A). At step 504, the quasi-account number may be received from a financial institution. For example, computing platform 318 may receive the quasi-account number (e.g., R#A:QA#1) from computing system 312 (e.g., FI A). At step 506, the quasi-account number may be sent to the user. For example, computing platform 318 may communicate the quasi-account number (e.g., R#A:QA#1) to computing system 302 (e.g., user A). At step 508, one or more authorization parameters for the quasi-account number may be received. For example, computing platform 318 may receive the one or more authorization parameters (e.g., the authorization parameter(s) indicating that the amount corresponding to the rent due to merchant B from user A is authorized for the quasi-account number once a month for the next twelve months) from computing system 302 (e.g., user A).

At step 510, a balance for a quasi-account associated with the quasi-account number may be established. For example, computing platform 318 may generate instructions configured to cause computing system 312 (e.g., FI A) to utilize a balance of the underlying account (e.g., user A's account) to establish a balance for a quasi-account associated with the quasi-account number (e.g., R#A:QA#1) in accordance with the authorization parameter(s), and computing platform 318 may communicate the instructions to computing system 312, which may execute the instructions (e.g., utilize, allocate, transfer, or the like a balance (e.g., available credit or deposited funds) of user A's account with FI A to establish a balance comprising the rent due for the quasi-account associated with the quasi-account number (e.g., R#A:QA#1) at the beginning of each of the next twelve months). At step 512, a request to transfer an amount from the quasi-account associated with the quasi-account number to another account may be received. For example, a transaction authorization request for a particular amount (e.g., the amount of rent due to merchant B from user A) may be received (e.g. via computing system 310) by computing system 312 (e.g., FI A) from computing system 308 (e.g., merchant B). At step 514, a determination may be made as to whether the request is authorized. For example, computing system 312 (e.g., FI A) may determine whether the quasi-account associated with the quasi-account number comprises a balance comprising the requested amount.

Responsive to determining that the quasi-account associated with the quasi-account number comprises a balance comprising the requested amount, at step 516, at least a portion of the balance of the quasi-account associated with the quasi-account number (e.g., the requested amount) may be transferred from the quasi-account. For example, responsive to determining that the quasi-account associated with the quasi-account number communicated to user system 302 (e.g., R#A:QA#1) comprises the amount included in the transaction authorization request received from computing system 308 (e.g., the rent due to merchant B from user A), computing system 312 (e.g., FI A) may transfer the amount to an account associated with computing system 314 (e.g., FI B) for transfer to the account associated with computing system 308 (e.g., merchant B). Responsive to determining that the quasi-account associated with the quasi-account number comprises a balance that does not comprise the requested amount, at step 518, a notification may be generated. For example, responsive to determining that the quasi-account associated with the quasi-account number communicated to user system 302 (e.g., R#A:QA#1) does not comprise the amount included in the transaction authorization request received from computing system 308 (e.g., the rent due to merchant B from user A that may have already been deducted for a particular month), computing system 312 (e.g., FI A) may generate a message (e.g., a decline notification) indicating that the transaction authorization request is not authorized because the quasi-account associated with the quasi-account number (e.g., R#A:QA#1) does not comprise the amount and may communicate (e.g., via computing system 310) the message indicating that the transaction authorization request is not authorized to computing system 308 (e.g., merchant B).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method comprising:
generating, by at least one processor of a computing platform comprising the at least one processor, a memory, and a communication interface, a request for a plurality of different quasi-account numbers for an account at a first financial institution;
communicating, via the communication interface and to a computing system associated with the first financial institution, the request for the plurality of different quasi-account numbers for the account at the first financial institution;
receiving, via the communication interface and from the computing system associated with the first financial institution, the plurality of different quasi-account numbers for the account at the first financial institution;
communicating, via the communication interface and to a computing system associated with the account at the first financial institution, the plurality of different quasi-account numbers for the account at the first financial institution;
generating, by the at least one processor, a request for a plurality of different quasi-account numbers for an account at a second financial institution;
communicating, via the communication interface and to a computing system associated with the second financial institution, the request for the plurality of different quasi-account numbers for the account at the second financial institution;
receiving, via the communication interface and from the computing system associated with the second financial institution, the plurality of different quasi-account numbers for the account at the second financial institution;
communicating, via the communication interface and to a computing system associated with the account at the second financial institution, the plurality of different quasi-account numbers for the account at the second financial institution;
receiving, via the communication interface and from the computing system associated with the account at the first financial institution, one or more authorization parameters for a quasi-account number of the plurality of different quasi-account numbers for the account at the first financial institution;
generating, by the at least one processor, instructions configured to cause the computing system associated with the first financial institution to utilize a balance associated with the account at the first financial institution to establish a balance for a quasi-account at the first financial institution having the quasi-account number of the plurality of different quasi-account numbers for the account at the first financial institution in accordance with the one or more authorization parameters for the quasi-account number of the plurality of different quasi-account numbers for the account at the first financial institution;
communicating, via the communication interface and to the computing system associated with the first financial institution, the instructions configured to cause the computing system associated with the first financial institution to utilize the balance associated with the account at the first financial institution to establish the balance for the quasi-account at the first financial institution;
receiving, via the communication interface and from the computing system associated with the account at the second financial institution, one or more authorization parameters for a quasi-account number of the plurality of different quasi-account numbers for the account at the second financial institution;
generating, by the at least one processor, instructions configured to cause the computing system associated with the second financial institution to utilize a balance associated with the account at the second financial institution to establish a balance for a quasi-account at the second financial institution having the quasi-account number of the plurality of different quasi-account numbers for the account at the second financial institution in accordance with the one or more authorization parameters for the quasi-account number of the plurality of different quasi-account numbers for the account at the second financial institution; and
communicating, via the communication interface and to the computing system associated with the second financial institution, the instructions configured to cause the computing system associated with the second financial institution to utilize the balance associated with the account at the second financial institution to establish the balance for the quasi-account at the second financial institution.

2. The method of claim 1, comprising:
receiving, by the computing system associated with the first financial institution, a first request to transfer an amount requested by an account holder of a different account at the second financial institution from the quasi-account at the first financial institution to the second financial institution; and
responsive to a determination by the computing system associated with the first financial institution that the balance for the quasi-account at the first financial institution comprises the amount requested by the account holder of the different account at the second financial institution, transferring, by the computing system associated with the first financial institution, the amount requested by the account holder of the different account at the second financial institution from the quasi-account at the first financial institution to the second financial institution for transfer by the second financial institution to the different account at the second financial institution.

3. The method of claim 2, comprising:
receiving, by the computing system associated with the first financial institution and after receiving the first request to transfer the amount requested by the account holder of the different account at the second financial institution, a second request to transfer the amount requested by the account holder of the different account at the second financial institution from the quasi-account at the first financial institution to the second financial institution; and
responsive to a determination by the computing system associated with the first financial institution that the balance for the quasi-account at the first financial institution does not comprise the amount requested by the account holder of the different account at the second financial institution:
generating, by the computing system associated with the first financial institution, a notification indicating that the quasi-account at the first financial institution does not comprise the amount requested by the account holder of the different account at the second financial institution; and
communicating, by the computing system associated with the first financial institution and to the computing system associated with the second financial institution, the notification indicating that the quasi-account at the first financial institution does not comprise the amount requested by the account holder of the different account at the second financial institution.

4. The method of claim 3, comprising:
receiving, by the computing system associated with the first financial institution and after receiving the second request to transfer the amount requested by the account holder of the different account at the second financial institution, a third request to transfer the amount requested by the account holder of the different account at the second financial institution from the quasi-account at the first financial institution to the second financial institution; and
responsive to a determination by the computing system associated with the first financial institution that the balance for the quasi-account at the first financial institution comprises the amount requested by the account holder of the different account at the second financial institution, transferring, by the computing system associated with the first financial institution, the amount requested by the account holder of the different account at the second financial institution from the quasi-account at the first financial institution to the second financial institution for transfer by the second financial institution to the different account at the second financial institution.

5. The method of claim 4, wherein:
the different account at the second financial institution is associated with a merchant;
each of the first request, the second request, and the third request comprises data, communicated by the computing system associated with the account at the first financial institution to a computing system associated with the merchant, communicated by the computing system associated with the merchant to the computing system associated with the second financial institution, and comprising the quasi-account number of the plurality of different quasi-account numbers for the account at the first financial institution;
receiving the one or more authorization parameters for the quasi-account number of the plurality of different quasi-account numbers for the account at the first financial institution comprises receiving data indicating that a recurring charge of the amount requested by the account holder of the different account at the second financial institution is authorized at a specified interval;
generating the instructions configured to cause the computing system associated with the first financial institution to utilize the balance associated with the account at the first financial institution to establish the balance for the quasi-account at the first financial institution comprises generating instructions configured to cause the computing system associated with the first financial institution to transfer, at the specified interval, the amount requested by the account holder of the different account at the second financial institution from the account at the first financial institution to the quasi-account at the first financial institution;
receiving the first request comprises receiving the first request after a first occurrence of the specified interval;
receiving the third request comprises receiving the third request after a second occurrence of the specified interval; and
receiving the second request comprises receiving the second request after the first occurrence and before the second occurrence.

6. The method of claim 5, wherein receiving the one or more authorization parameters for the quasi-account number of the plurality of different quasi-account numbers for the account at the first financial institution comprises receiving the one or more authorization parameters for the quasi-account number of the plurality of different quasi-account numbers for the account at the first financial institution before the data comprising the quasi-account number is communicated by the computing system associated with the account at the first financial institution to the computing system associated with the merchant.

7. The method of claim 5, wherein receiving the one or more authorization parameters for the quasi-account number of the plurality of different quasi-account numbers for the account at the first financial institution comprises receiving the one or more authorization parameters for the quasi-account number of the plurality of different quasi-account numbers for the account at the first financial institution after the data comprising the quasi-account number is communicated by the computing system associated with the account at the first financial institution to the computing system associated with the merchant.

8. The method of claim 2, comprising:
receiving, by the computing system associated with the second financial institution, a request to transfer an amount requested by an account holder of a different account at the first financial institution from the quasi-account at the second financial institution to the first financial institution; and
responsive to a determination by the computing system associated with the second financial institution that the balance for the quasi-account at the second financial institution comprises the amount requested by the account holder of the different account at the first financial institution, transferring, by the computing system associated with the second financial institution, the amount requested by the account holder of the different account at the first financial institution from the quasi-account at the second financial institution to the first financial institution for transfer by the first financial institution to the different account at the first financial institution.

9. The method of claim 8, comprising:
receiving, by the computing system associated with the second financial institution, a request to transfer a different amount requested by the account holder of the different account at the second financial institution from the quasi-account at the second financial institution to the different account at the second financial institution; and
responsive to a determination by the computing system associated with the second financial institution that the balance for the quasi-account at the second financial institution does not comprise the different amount requested by the account holder of the different account at the second financial institution:
generating, by the computing system associated with the second financial institution, a notification indicating that the quasi-account at the second financial institution does not comprise the different amount requested by the account holder of the different account at the second financial institution; and
communicating, by the computing system associated with the second financial institution and to a computing system associated with the account holder of the different account at the second financial institution, the notification indicating that the quasi-account at the second financial institution does not comprise the different amount requested by the account holder of the different account at the second financial institution.

10. The method of claim 9, wherein:
the different account at the first financial institution is associated with a first merchant;
the different account at the second financial institution is associated with a second merchant;
the computing system associated with the account holder of the different account at the second financial institution is associated with the second merchant;
the request to transfer the amount requested by the account holder of the different account at the first financial institution comprises data, communicated by the computing system associated with the account at the second financial institution to a computing system associated with the first merchant, communicated by the computing system associated with the first merchant to the computing system associated with the first financial institution, and comprising the quasi-account number of the plurality of different quasi-account numbers for the account at the second financial institution;
the request to transfer the different amount requested by the account holder of the different account at the second financial institution comprises data, communicated by a computing system other than the computing system associated with the account at the second financial institution to the computing system associated with the account holder of the different account at the second financial institution, and comprising the quasi-account number of the plurality of different quasi-account numbers for the account at the second financial institution;
receiving the one or more authorization parameters for the quasi-account number of the plurality of different quasi-account numbers for the account at the second financial institution comprises receiving data indicating that a one-time charge of the amount requested by the account holder of the different account at the first financial institution is authorized;
generating the instructions configured to cause the computing system associated with the second financial institution to utilize the balance associated with the account at the second financial institution to establish the balance for the quasi-account at the second financial institution comprises generating instructions configured to cause the computing system associated with the second financial institution to transfer the amount requested by the account holder of the different account at the first financial institution from the account at the second financial institution to the quasi-account at the second financial institution; and
receiving the request to transfer the amount requested by the account holder of the different account at the first financial institution comprises receiving, at a first time, the request to transfer the amount requested by the account holder of the different account at the first financial institution; and
receiving the request to transfer the different amount requested by the account holder of the different account at the second financial institution comprises receiving, at a second time, the request to transfer the different amount requested by the account holder of the different account at the second financial institution, the second time being later in time than the first time.

11. The method of claim 10, wherein receiving the one or more authorization parameters for the quasi-account number of the plurality of different quasi-account numbers for the account at the second financial institution comprises receiving the one or more authorization parameters for the quasi-account number of the plurality of different quasi-account numbers for the account at the second financial institution before the data comprising the quasi-account number is communicated by the computing system associated with the account at the second financial institution to the computing system associated with the first merchant.

12. The method of claim 10, wherein receiving the one or more authorization parameters for the quasi-account number of the plurality of different quasi-account numbers for the account at the second financial institution comprises receiving the one or more authorization parameters for the quasi-account number of the plurality of different quasi-account numbers for the account at the second financial institution after the data comprising the quasi-account number is communicated by the computing system associated with the account at the second financial institution to the computing system associated with the first merchant.

13. The method of claim 8, wherein:
a first routing number is associated with the first financial institution;
a second routing number is associated with the second financial institution;
receiving the first request comprises receiving data, communicated by the computing system associated with the account at the first financial institution to a computing system associated with a first merchant, communicated by the computing system associated with the first merchant to the computing system associated with the second financial institution, and comprising the first routing number and the quasi-account number of the plurality of different quasi-account numbers for the account at the first financial institution; and
receiving the request to transfer the amount requested by the account holder of the different account at the first financial institution comprises receiving data, communicated by the computing system associated with the account at the second financial institution to a computing system associated with a second merchant, communicated by the computing system associated with the second merchant to the computing system associated with the first financial institution, and comprising the second routing number and the quasi-account number of the plurality of different quasi-account numbers for the account at the second financial institution, the account holder of the different account at the second financial institution being the first merchant, and the account holder of the different account at the first financial institution being the second merchant.

14. The method of claim 13, wherein the first routing number comprises a number of digits, and wherein the second routing number comprises the number of digits.

15. The method of claim 14, wherein the number is nine.

16. The method of claim 8, wherein the account at the first financial institution is associated with a first account number, wherein the account at the second financial institution is associated with a second account number, wherein the first request does not comprise the first account number, and wherein the request to transfer the amount requested by the account holder of the different account at the first financial institution does not comprise the second account number.

17. The method of claim 16, wherein the first account number comprises a number of digits, wherein the second account number comprises the number of digits, wherein each of the plurality of different quasi-account numbers for the account at the first financial institution comprises the number of digits, and wherein each of the plurality of different quasi-account numbers for the account at the second financial institution comprises the number of digits.

18. The method of claim 17, wherein the number is greater than nine.

19. A computing platform comprising:
at least one processor;
a communication interface; and
a memory comprising instructions that when executed by the at least one processor cause the computing platform to:
generate a request for a plurality of different quasi-account numbers for an account at a first financial institution;
communicate, via the communication interface and to a computing system associated with the first financial institution, the request for the plurality of different quasi-account numbers for the account at the first financial institution;
receive, via the communication interface and from the computing system associated with the first financial institution, the plurality of different quasi-account numbers for the account at the first financial institution;
communicate, via the communication interface and to a computing system associated with the account at the first financial institution, the plurality of different quasi-account numbers for the account at the first financial institution;
generate a request for a plurality of different quasi-account numbers for an account at a second financial institution;
communicate, via the communication interface and to a computing system associated with the second financial institution, the request for the plurality of different quasi-account numbers for the account at the second financial institution;
receive, via the communication interface and from the computing system associated with the second financial institution, the plurality of different quasi-account numbers for the account at the second financial institution;
communicate, via the communication interface and to a computing system associated with the account at the second financial institution, the plurality of different quasi-account numbers for the account at the second financial institution;
receive, via the communication interface and from the computing system associated with the account at the first financial institution, one or more authorization parameters for a quasi-account number of the plurality of different quasi-account numbers for the account at the first financial institution;
generate instructions configured to cause the computing system associated with the first financial institution to utilize a balance associated with the account at the first financial institution to establish a balance for a quasi-account at the first financial institution having the quasi-account number of the plurality of different quasi-account numbers for the account at the first financial institution in accordance with the one or more authorization parameters for the quasi-account number of the plurality of different quasi-account numbers for the account at the first financial institution;
communicate, via the communication interface and to the computing system associated with the first financial institution, the instructions configured to cause the computing system associated with the first financial institution to utilize the balance associated with the account at the first financial institution to establish the balance for the quasi-account at the first financial institution;
receive, via the communication interface and from the computing system associated with the account at the second financial institution, one or more authorization parameters for a quasi-account number of the plurality of different quasi-account numbers for the account at the second financial institution;
generate instructions configured to cause the computing system associated with the second financial institution to utilize a balance associated with the account at the second financial institution to establish a balance for a quasi-account at the second financial institution having the quasi-account number of the plurality of different quasi-account numbers for the account at the second financial institution in accordance with the one or more authorization parameters for the quasi-account number of the plurality of different quasi-account numbers for the account at the second financial institution; and
communicate, via the communication interface and to the computing system associated with the second financial institution, the instructions configured to cause the computing system associated with the second financial institution to utilize the balance associated with the account at the second financial institution to establish the balance for the quasi-account at the second financial institution.

20. One or more non-transitory computer-readable media comprising instructions that when executed by at least one processor of a computing platform comprising the at least one processor and a communication interface cause the computing platform to:
generate a request for a plurality of different quasi-account numbers for an account at a first financial institution;
communicate, via the communication interface and to a computing system associated with the first financial institution, the request for the plurality of different quasi-account numbers for the account at the first financial institution;
receive, via the communication interface and from the computing system associated with the first financial institution, the plurality of different quasi-account numbers for the account at the first financial institution;
communicate, via the communication interface and to a computing system associated with the account at the first financial institution, the plurality of different quasi-account numbers for the account at the first financial institution;
generate a request for a plurality of different quasi-account numbers for an account at a second financial institution;
communicate, via the communication interface and to a computing system associated with the second financial institution, the request for the plurality of different quasi-account numbers for the account at the second financial institution;
receive, via the communication interface and from the computing system associated with the second financial institution, the plurality of different quasi-account numbers for the account at the second financial institution;
communicate, via the communication interface and to a computing system associated with the account at the second financial institution, the plurality of different quasi-account numbers for the account at the second financial institution;
receive, via the communication interface and from the computing system associated with the account at the first financial institution, one or more authorization parameters for a quasi-account number of the plurality of different quasi-account numbers for the account at the first financial institution;
generate instructions configured to cause the computing system associated with the first financial institution to utilize a balance associated with the account at the first financial institution to establish a balance for a quasi-account at the first financial institution having the quasi-account number of the plurality of different quasi-account numbers for the account at the first financial institution in accordance with the one or more authorization parameters for the quasi-account number of the plurality of different quasi-account numbers for the account at the first financial institution;
communicate, via the communication interface and to the computing system associated with the first financial institution, the instructions configured to cause the computing system associated with the first financial institution to utilize the balance associated with the account at the first financial institution to establish the balance for the quasi-account at the first financial institution;
receive, via the communication interface and from the computing system associated with the account at the second financial institution, one or more authorization parameters for a quasi-account number of the plurality of different quasi-account numbers for the account at the second financial institution;
generate instructions configured to cause the computing system associated with the second financial institution to utilize a balance associated with the account at the second financial institution to establish a balance for a quasi-account at the second financial institution having the quasi-account number of the plurality of different quasi-account numbers for the account at the second financial institution in accordance with the one or more authorization parameters for the quasi-account number of the plurality of different quasi-account numbers for the account at the second financial institution; and
communicate, via the communication interface and to the computing system associated with the second financial institution, the instructions configured to cause the computing system associated with the second financial institution to utilize the balance associated with the account at the second financial institution to establish the balance for the quasi-account at the second financial institution.
